(19) United States
(12) Patent Application Publication
(10) Pub. No.: US 2015/0009364 A1
(43) Pub. Date: Jan. 8, 2015

(54) MANAGEMENT AND ACCESS OF MEDIA WITH MEDIA CAPTURE DEVICE OPERATOR PERCEPTION DATA

(71) Applicants: Glen Anderson, Beaverton, OR (US); David Avrahami, Mountain View, CA (US)

(72) Inventors: Glen Anderson, Beaverton, OR (US); David Avrahami, Mountain View, CA (US)

(21) Appl. No.: 14/129,214

(22) PCT Filed: Jun. 25, 2013
(86) PCT No.: PCT/US2013/047557

§ 371 Date: Dec. 24, 2013

(51) Int. Cl. G06F 17/30; H04N 5/232

(52) U.S. Cl. CPC G06F 17/3028; G06F 17/30268; G06F 17/30274; H04N 5/23219
USPC 348/231.3

(57) ABSTRACT

Operator-centric perception data-driven systems and techniques for managing and accessing personal media captured by a device while under the control of the operator. Operator perception data, for example, parameterizing a physiological state, attribute, or mood of the operator during a media capture event originating certain media data, is associated, as an additional input at media capture time, with subject-centric media data generated by the capture device. This association may then be subsequently stored to enrich the media data, and automate, or otherwise simplify post-capture access and processing of the captured media data.

### TECHNICAL FIELD

Embodiments of the invention generally relate to perceptual computing, and more particularly pertain to media data management and access based on perceptions of a media capture device operator.

### BACKGROUND

With declining costs of mass storage, media capture devices have become ubiquitous in modern society. Both the number of media captmachine-readable, for example in the form of smart glasses, smart watches, etc. The volume of media associated with each capture device user or operator will therefore likely increase significantly in the coming decade.

While vast quantities of personal media data generated by media capture devices may now be inexpensively stored, management and access of stored media data remains a challenge because of the large number of man-hours currently needed in post-processing or analysis of the media data. For example, sophisticated post-capture processing (e.g., categorizing, and otherwise tagging or filtering the captured media data) remains too labor-intensive to be conducted in real-time with the media capturing process, which is now highly automated. Yet inadequate/rudimentary post-capture processing may leave a media capture device user/operator feeling overwhelmed by the sheer volume of their stored media data. Furthermore, a capture device operator may also face a labor-intensive analysis of time sequenced raw media data when they wish to recall media data generated by a particular capture device during a particular capture event occurring at a time imprecisely known. In essence, important media data snippets may become a “needle in the haystack” of stored personal media data. Techniques and systems able to alleviate one or more of the challenges associated with management and access of personal media data are therefore advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a functional block diagram depicting an architecture of an exemplary system for capturing media data as well as managing, and accessing the captured media data based on perceptions of a capture device operator, in accordance with an embodiment;

FIG. 2 is a flow diagram illustrating an exemplary computer-implemented method for managing captured media data based on perceptions of a capture device operator, in accordance with an embodiment;

FIG. 3 is a flow diagram illustrating an exemplary computer-implemented method for accessing and managing captured media data based on perceptions of a capture device operator, in accordance with an embodiment;

FIG. 4 illustrates an example of how captured media data may be managed and accessed through the methods in FIG. 2 or 3 by a system having an architecture as in FIG. 1, in accordance with an embodiment;

FIGS. 5A, 5B, and 5C illustrate perception data structures and links between perception data structures and media data structures, in accordance with embodiments;

FIG. 6A illustrates a portion of an exemplary media data effect correlation database, in accordance with embodiments;

FIGS. 6B, 6C illustrate an exemplary reversible modification of a media data file based on a modification function determined from the media data effect correlation database depicted in FIG. 6A, in accordance with embodiments;

FIG. 7 is an illustrative diagram of an exemplary system, in accordance with embodiments; and

FIG. 8 is an illustrative diagram of an exemplary system, arranged in accordance with an embodiment.

### DETAILED DESCRIPTION

One or more embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. Therefore, the following detailed description is not to be taken in a limiting sense and the scope of claimed subject matter is defined solely by the appended claims and their equivalents.

In the following description, numerous details are set forth, however, it will be apparent to one skilled in the art, that the present invention may be practiced without these specific details. Well-known methods and devices are shown in block diagram form, rather than in detail, to avoid obscuring the present invention. Reference throughout this specification to “an embodiment” or “one embodiment” means that a particular feature, structure, function, or characteristic described in connection with the embodiment is included in at least one embodiment of the invention. Thus, the appearances of the phrase “in an embodiment” or “in one embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

As used in throughout this description, and in the claims, a list of items joined by the term “at least one of” or “one or more of” can mean any combination of the listed terms. For example, the phrase “at least one of A. B or C” can mean A; B; C; A and B; A and C; B and C; or A, B and C.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical, optical, or electrical contact with each other, and/or that the two or more elements co-operate or interact with each other (e.g., as in a cause an effect relationship).

Some portions of the detailed descriptions provide herein are presented in terms of algorithms and symbolic representations of operations on data bits within a computer memory. Unless specifically stated otherwise, as apparent from the following discussion, it is appreciated that throughout the description, discussions utilizing terms such as “calculating,” “computing,” “determining” “estimating” “storing” “collecting” “displaying,” “receiving,” “consolidating,” “generating,” “updating,” or the like, refer to the action and processes of a computer system, or similar electronic computing device, that manipulates and transforms data represented as physical (electronic) quantities within the computer system's circuitry including registers and memories into other data similarly represented as physical quantities within the computer system memories or registers or other such information storage, transmission or display devices.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For example, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. Furthermore, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other similarly non-transitory, tangible media.

Systems, apparatus, articles, and methods are described below including operations for managing and accessing personal media data based on a perception of an operator of the device that captured the media data, as determined during a capture event.

As described above, searching and editing captured media data may, in absence of the operator-centric perception data driven systems and techniques described in embodiments herein, be difficult and time consuming tasks. As described in greater detail below, operator perception data is associated, as an additional input at media capture time, with the media data captured by the capture device. As used herein, perception data is data that parameterizes a physiological or emotional attribute or state of the operator. An example of perception data parameterizing a physiological state, is a heart rate of the operator. Perception data may also be one or more of various predefined physiological or emotional states attributed to the operator as abstracted from data values output by sensors based on predetermined criteria, or thresholds, etc. For example, where heart rate is <80 bpm, a physiological state of “resting” may be attributed to the operator. Or where other sensor data values satisfy a certain criteria, an operator's emotional state may be assigned “happy,” etc. An association between media data and perception data that corresponds to the operator during a media capture event originating the media data may be stored and further employed to automate and/or otherwise simplify post-capture management and accessing of the media data.

As described in greater detail below in the context of certain exemplary embodiments, any capture device with a capture sensor, or capture sensor, may be operated during a media capture event to collect media data, such as, still frame image data, video streaming data, audio data, or the like. The media data is associated with a subject, for example a person in a still frame image, and therefore may be referred to as “subject-centric” media data. One or more perception sensor may be further deployed, for example as a component of the media capture device, or as a component of an independent perceptual computing device. Perception data collected from the operator through the perception sensor during a media capture event conducted by the media capture device may be analyzed through middleware that parameterizes an attribute or state of the operator. This “operator-centric” perception data is then associated with the subject-centric media data generated by the media capture device, for example through time synchronization of a perception data stream with media capture events. Meta-data particular to conditions of the capture device operator during the media capture event may then be linked or embedded with media data files. Such tagging of the media data files may then serve as enriching attributes useful for browsing, searching, editing, summarizing, or otherwise managing the media data. Such operator-centric perception data may be further combined with general contextual information such as media capture location, weather conditions at capture time, presence of other people, etc. In embodiments, editing of the media data may be predicated on perception of an operator at the time of media data capture, for example through application of one or more modification functions having a predetermined correspondence with certain operator states or attributes parameterized by the operator-centric perception data.

For these embodiments, operator-centric attributes (e.g., mood, attention, or stress level, etc.) may be applied on top of subject-centric media data that may otherwise have a frame of reference limited to the point of view (POV) of the operator and lack and operator-centric attributes. Personal media is often managed, post-processed, and viewed/accessed by the individual who operated the media capture device at the time of capture. Therefore, operator-centric perception data collected contemporaneously with a capture event may be a particularly useful enrichment enabling automation of the tasks associated with subsequently managing and accessing the resultant media data. Furthermore, the benefits of perceptual computing devices may be integrated with numerous independent and inexpensive capture devices otherwise lacking perceptive computing capability, permitting a more-unified management/access interface across the capture devices. For example, a given operator-centric perception sensor(s) may be utilized in conjunction with plurality of media capture devices (either simultaneously or on a time divided basis) that each have a set of subject-centric sensors. The perception sensor(s) data may then be correlated with separate media data originated from the individual capture devices.

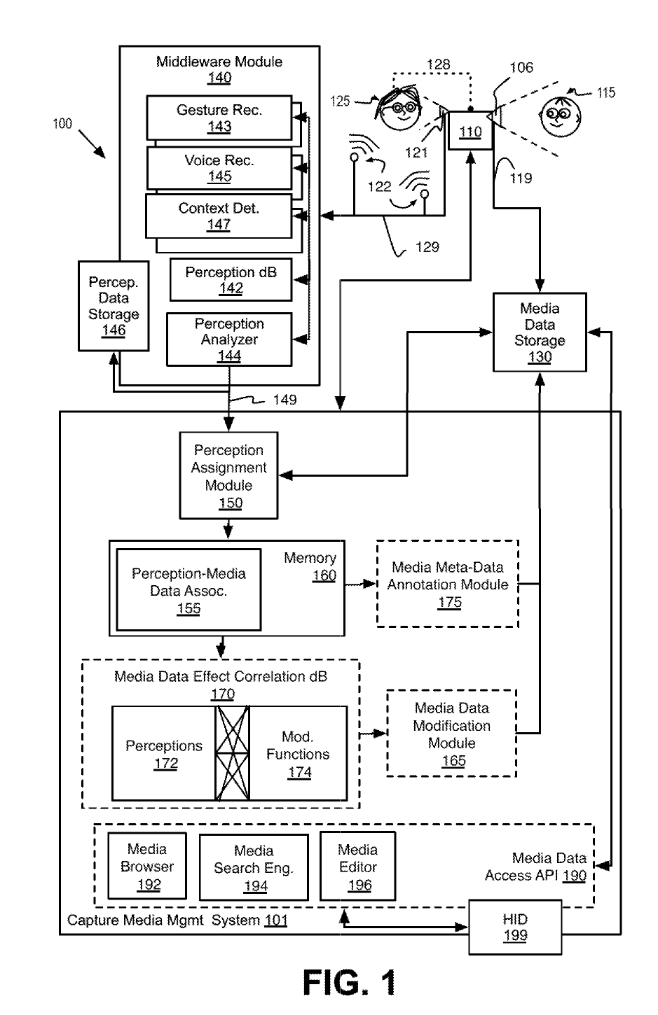

FIG. 1 is a functional block diagram depicting an architecture of an exemplary system 100 for capturing media data as well as managing, and accessing the captured media data based on perceptions of a capture device operator, in accordance with an embodiment. System 100 includes media capture device 110 having one or more media capture sensor 106. In exemplary embodiments, media capture device 110 includes, or is a component of, a mobile computing platform, such as a wireless smartphone, tablet computer, ultrabook computer, or the like. In other embodiments, media capture device 110 may be any wearable device, such as a headset, wrist computer, etc., or may be any immobile sensor installation, such as a security camera, etc. In still other embodiments, media capture device 110 may be an infrastructure device, such as a television, set-top box, desktop computer, etc. Media capture device 110 is generally assigned to a media capture device operator 125, for example through a profile of the media capture device 100. In FIG. 1, the association between operator 125 and media capture device 110 is represented by a dashed lined device link 128 as the capture device operator designation may vary across different operational contexts of the media capture device, or over time, etc.

Generally, media capture sensor 106 is any conventional sensor or sensor array capable of collecting media data. In certain embodiments, for example where the capture device 110 is a mobile computing platform, the media capture sensor 106 has a field of view (FOV) that is oriented to capture media data pertaining to a subject 115 from the POV of operator 125. In certain other embodiments, for example where the capture device 110 is immobile, the media capture sensor 106 has a field of view (FOV) that is oriented to also capture media data including operator 125. Specific examples of media capture sensor 106 include a still frame an or motion video image sensor (e.g., CMOS sensor), and/or audio microphone.

Media data capture device 110 outputs, or streams, etc., media data 119, which is then stored in media data storage 130. In exemplary embodiments, media data 119 is in a raw native, uncompressed format of the capture device 110, although it may also be in a compressed or otherwise encoded into a standardize format. Media data storage 130 may entail any conventional storage, such as a flash memory chip on-board the media data capture device 110, or such as a hard disk drive that may be remote from the capture device 110 (e.g., with cloud access only).

System 100 further includes one or more operator perception sensors 121, 122 (e.g., forming a sensor ensemble) that have operator 125 within the perception sensor FOV. Generally, an operator perception sensor may be integrated within media capture device 110, as exemplified by operator perception sensor 121. Alternatively, an operator perception sensor may be external to media capture device 110, as exemplified by operator perception sensor(s) 122. A plurality of integrated and/or discrete sensors 121, 122 may form part of a distributed sensor array, that may be, for example, associated with operator 125 as a result of a device profile (e.g., represented in FIG. 1 by dashed line 128) or as a result of mere proximity of operator 125 to sensors 121, 122 at a particular time. Generally, each operator perception sensor 121, 122 may be any biometric, environmental, or haptic sensor/sensor array. The sensor data collected may directly parameterize operator 125, or serve as a basis for deriving such a parameterization, with each sensor outputting one or more fields of perception sensor data 129, for example through conventional wireless/wired network/internet connectivity. Exemplary perception sensors include: a still or video image sensor (e.g., a rear-facing sensor in media capture device 110 outputting a facial image of operator 125); a microphone (outputting an audio recording of operator 125 as a perception sensor data field); a heart rate monitor (outputting heart rate of operator 125 as a perception sensor data field); a blood pressure monitor (outputting blood pressure of operator 125 as a perception sensor data field); an electrodermal sensor (outputting a galvanic skin response of operator 125 as a perception sensor data field); an electroencephalograph (outputting electrical brain activity of operator 125 as a perception sensor data field); and cerebral blood flow sensor (outputting blood flow levels within regions of the brain of operator 125 as a perception sensor data field).

System 100 further includes middleware module 140, which is to receive perception sensor data 129 having potentially many native forms (e.g., analog, digital, continuously streamed, aperiodic, etc.) and is to generate perception data 149 having predetermined fields parameterizing operator 125. In one embodiment, middleware module 140 further functions as a hub multiplexing and/or de-multiplexing a plurality of streams of sensor data 129. Generally, middleware module 140 may be a component of the media capture device 110, or may be part of a separate platform. Middleware module 140 may employ one or more sensor data processing module, such as gesture recognition module 143, voice recognition module 145, context determination module 147, etc. each employing an algorithm to transform the perception sensor data 129 into a form that can be analyzed by perception analyzer 144 (e.g., based on perception database 142 correlating one or more type and/or value of sensor data 129 into parameterized fields of perception data 149). Generally, depending on the implementation of middleware module 140, perception data 149 may be a low level parameterization, such as an operator's voice command, gesture, or facial expression (e.g., smile, frown, grimace, etc.), or a higher level abstraction, such as an operator's mood, a level of attention, or a cognitive load (i.e., a measure of mental effort) that may be inferred or derived indirectly from one or more fields in sensor data 129. For example, a level of attention may be estimated based on eye tracking and/or on a rate of blinking, etc., while a cognitive load may be inferred based on pupil dilation and/or a heart rate-blood pressure product. Embodiments of the invention are not limited with respect to specific transformations of sensor data 129 into perception data 149. Therefore, no further description of middleware module 140 is provided herein.

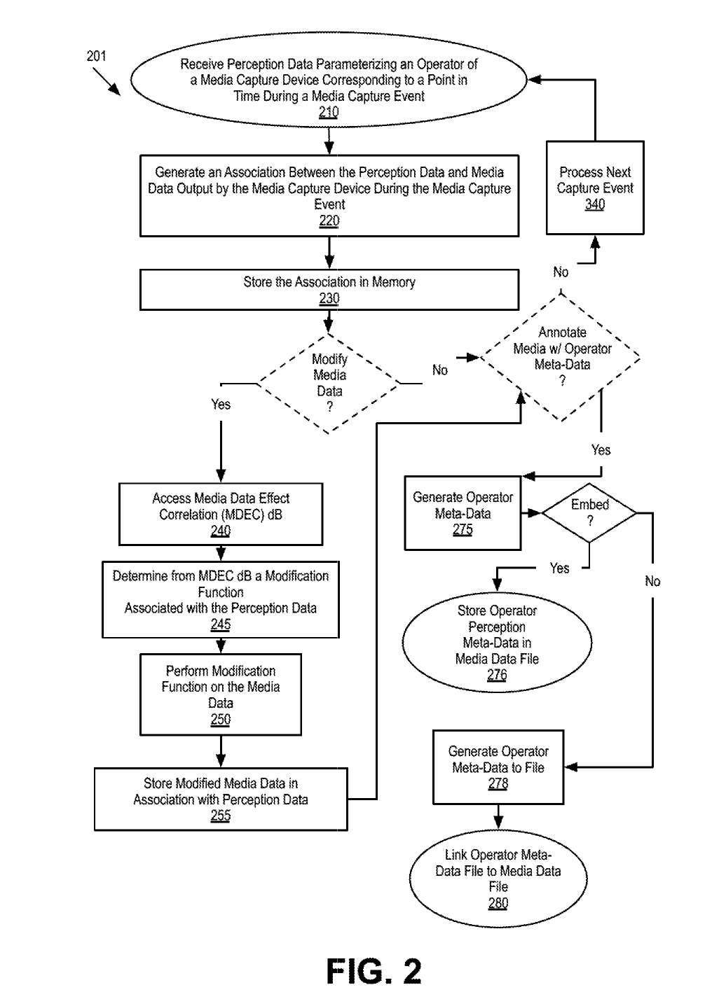

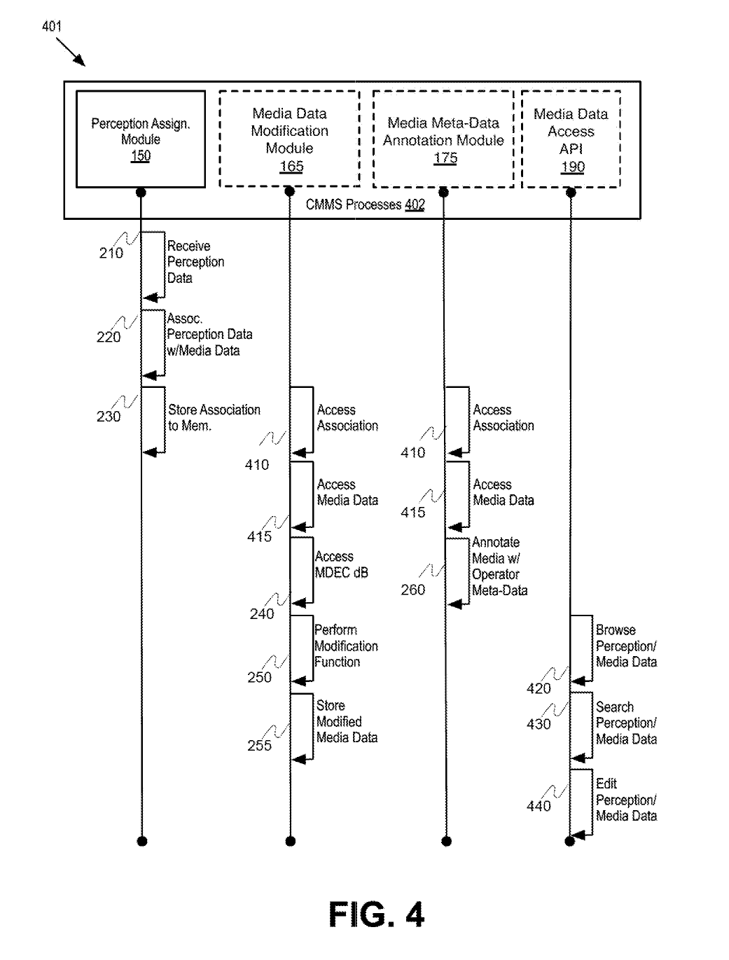

System 100 further includes capture media management system (CMMS) 101. CMMS 101 may be implemented in hardware, firmware, software, or a combination thereof. Of course, even for software implementations, an instantaneous combination of physical states of integrated circuitry elements, such as registers define a structural instantiation of a software module. For example, in one embodiment, CMMS 101 is a processing thread executed by, or instantiated with an applications processor IC, which may be integrated in the media capture device 110, or a separate platform. In a further embodiment, CMMS 101 includes memory 160, which may be a portion of an electronic memory reserved by CMMS 101. Suitable electronic memories include a Static Random Access Memory (SRAM) or Embedded Dynamic Random Access Memory (eDRAM) L1 cache within the applications processor. Non-volatile memory (e.g., flash memory, etc.) may also be utilized. CMMS 101 is to invoke, or cause a processor executing a CMMS thread to invoke, one or more module responsible for executing one or more automated processes managing captured media data, based on perceptions of a capture device operator. In the embodiment illustrated in FIG. 1, for example CMMS 101 further includes a perception assignment module 150. Specific processes performed by various circuitry and/or instantiations represented by the perception assignment module 150 are further described in the context of FIG. 2 in a flow diagram illustrating a computer-implemented method, 201. In accordance with the specific embodiment further illustrated in FIG. 4, the perception assignment module 150 of FIG. 1 executes the operations 210, 220, and 230 as one of the CMMS processes 402 invoked by CMMS 101.

In embodiments, perception data corresponding to sensor data collected contemporaneously with a media capture event is associated with the captured media data. Referring to FIG. 2, method 201 begins at operation 210 with receiving perception data parameterizing an operator of a media capture device, and corresponding to one or more points in time during a media capture event (e.g., perception data 149 in FIG. 1). At operation 220, an association is generated between perception data and media data output by a media capture device during a media capture event (e.g., media data 119 in FIG. 1). At operation 230, the perception-media data association is stored in memory. For example, as further shown in FIG. 1, perception-media data association 155 is stored to memory 160.

Perception data collected or generated for only a single point in time, or for multiple points in time during a media capture event may be associated with the media capture event. For example, there may be perception data (e.g., operator pupil diameter) corresponding to each captured video frame of a multi-framed video. Where perception data corresponds to multiple points in time, individual perception data values may be associated with individual portions of the media data (e.g., a pupil diameter value associated with a given set of frames during capture of a video data sequence), and/or reduced to a nominal perception value through statistical techniques, or similar, that is representative of an entire media capture event (e.g., an average pupil diameter over the multiple points in time during capture of a video data sequence). Noting that the perception data 149 may be abstracted considerably from the sensor data 129, a single perception data item may correspond to many media data items. For example, where the media data pipeline streams at 60 frames per second for a video data embodiment, the perception data pipeline may output one operator mood perception data item per 4 seconds of sensor data, which is stored to perception data storage 146 along with an indication of the corresponding sensor data collection time span. Generation of perception data 149 may be continuous, but need not be. For example, where the media data pipeline is not significantly faster than the perception data pipeline, perception data generation may be triggered in response to a media capture event for a 1:1 correspondence of perception data 149 with media data 116. As such, the specific manner in which the perception data is associated with the media data depends on at least the perception data collection system architecture and respective data pipelining and so only a few general examples are provided below.

Referring again to FIG. 1, in one exemplary embodiment where perception sensor 121, or 122 or middleware module 140 is in communication with media capture device 110, each item of perception data 149 may correspond to sensor data 129 collected in response to, or triggered by, a media capture event. In such an embodiment, all perception data 149 stored in perception data storage 146 may be organized as files with contemporaneous perception-media data associations then generated by linking a perception data file with a media data file having approximately the same file creation time. In another embodiment where CMMS 100 is in communication with media capture device 110, an indication of a media capture event may be communicated to CMMS 100 and perception assignment module 150 may then poll for perception data 149 corresponding to sensor data 129 collected contemporaneously with the media capture event. Alternatively, perception assignment module 150 may access perception data 149 (e.g., with many data items in a perception data file stored in perception data storage 146) identifiable (e.g., through meta-data, etc.) as corresponding to sensor data 129 collected contemporaneously with the media capture event. One or more items of the perception data 149 received in response to the polling or as identified from the perception data storage 146 is then associated with the media data 119. In another alternative embodiment, where media data 119 includes meta-data indicative of a media capture event (e.g., a capture time stamp), neither middleware module 140 nor CMMS 100 need be in communication with media capture device 110. In such an embodiment, perception assignment module 150 may access media data 119, for example as a media data file stored in the media data storage 130, and determine one or more capture event time stamp, such as a time of exposure for still frame image data, or time of exposure associated with one or more time sequenced video frames, by any conventional technique. Perception assignment module 150 may then access perception data 149, (e.g., as stored in perception data storage 146), and search for items identifiable as corresponding to sensor data 129 collected contemporaneously with the media capture event resulting in the media data 119. An item of the perception data 149 identified from the perception data storage 146 is then associated with an item of the media data 119, for example by assigning a pointer between the two items.

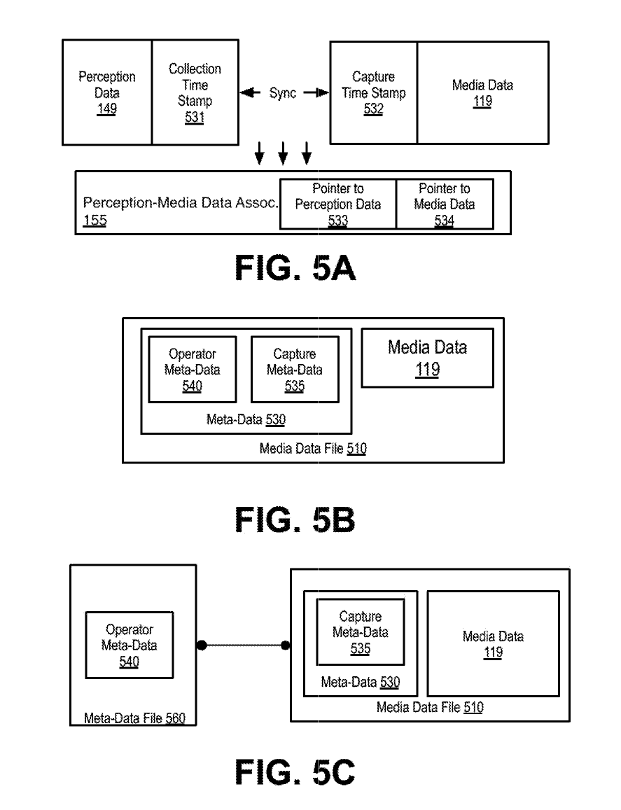

FIG. 5A illustrates one exemplary data structure of where perception data 149 has embedded meta-data including a collection time stamp 531 defining a time of collection of the operator perception data. Likewise, media data 119 has embedded meta-data including a capture time stamp 532 defining a time of capture of the media data. With such a data structure, identification the perception data 149 and media 119 that are to be associated may be based on a synchronization of the data files where the time stamp 531 matches time stamp 532 under an arbitrary predetermined heuristic. As so identified, first pointer 533 referencing a location in memory associated with a particular perception data item, and a second pointer 534 referencing a location in memory associated with a particular media data item may then be maintained in the memory as items of the perception-media data association 155. For embodiments where the media data is a time sequenced series of image data (e.g., video data), a capture time stamp 532 may be associated with one or more video frames and the collection time stamp 531 may correspond with a time window spanning many frames of the image data. Any conventional techniques for time referencing and synchronizing may be utilized to identify subsets of video frames that correspond to a particular perception data item. Every frame within that subset may then be associated with the perception data item.

In embodiments, captured media data is modified based on operator perception data. Returning to FIG. 1, in an embodiment, the CMMS 101 further includes a media meta-data modification module 165. The media data modification module 165 is drawn in dashed line to emphasize it is an optional component of CMMS 101. Generally, the media data modification module 165 is to transform the media data 119 into modified data based on associated perception data 149. In the specific embodiment shown in FIG. 4, various circuitry and/or instantiations represented by the media data modification module 165 access a perception-media data association stored in memory at operation 410. The media data modification module 165 then access the corresponding media data at operation 415, and executes operations 240, 245, 250, and 255 of method 201 in FIG. 2 as one of the CMMS processes 402 invoked by CMMS 100.

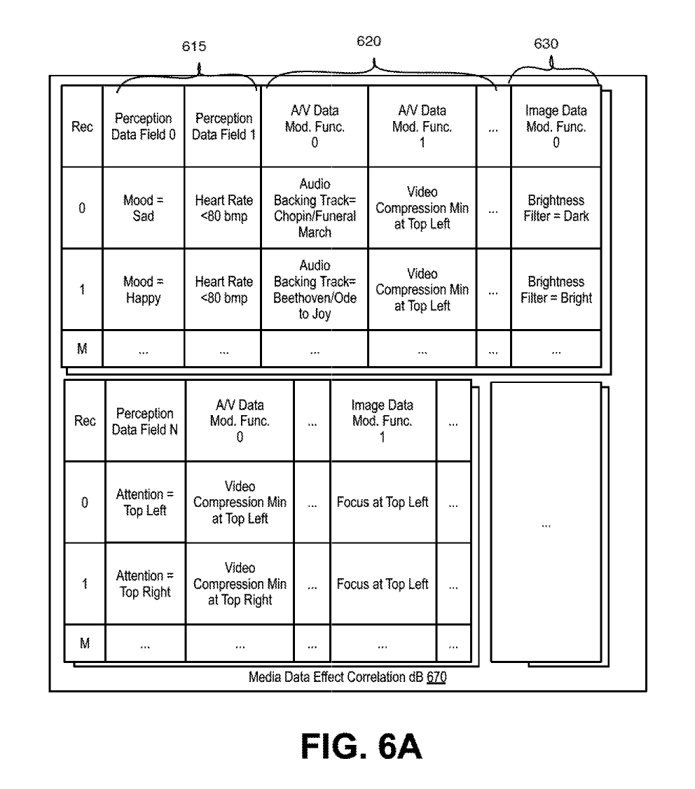

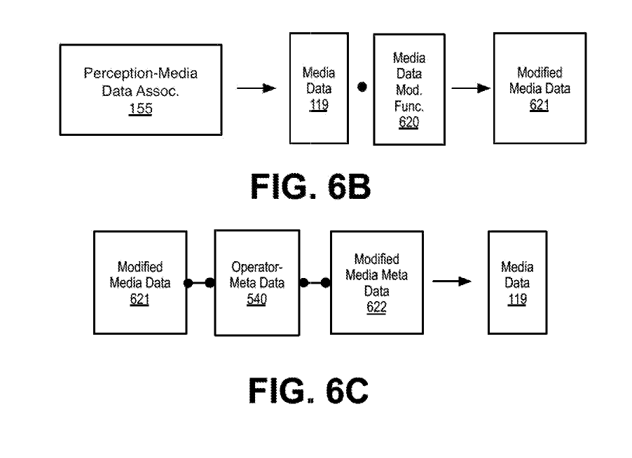

As further shown in FIG. 2, with the perception-media data association stored in memory at operation 230, flow control branches depending on whether media data 119 stored in media data storage 130 is to be modified. This decision may be automated based on one or more value of perception data 149 associated with media data 119, or may be predicated on additional user input. If a modification of media data is triggered, the method 201 proceeds to operation 240 where a media data effect correlation (MDEC) database (e.g., MDEC dB 170 in FIG. 1) is accessed. Generally, a MDEC database relates predetermined perception data values or conditions (e.g., perceptions 172 in FIG. 1) with predetermined media data modification functions (e.g., Mod. Functions 174 in FIG. 1). More particularly, a MDEC database includes one or more predetermined perception data field and a plurality of predetermined media data modification functions, with each of the modification functions being associated with one or more predetermined perception data field value. FIG. 6A illustrates a portion of an exemplary MDEC database 610, in accordance with embodiments. As shown in FIG. 6A, MDEC database 610 includes a lookup table with plurality of records 0-M with an individual record including a value in one or more perception data fields 615 and a corresponding effect or modification prescribed for one or more class or type of media data, such as A/V media modification functions 620, or still frame image data modification functions 630. Other tables depicted in the MDEC database 610 correlate perception data pertaining to an operator's point of attention (e.g., as determined by a gaze tracker in middleware module 140 of FIG. 1) with a region within a frame of image data to be digitally compressed relatively less for highest fidelity, or to be refocused (applicable for light field media data). Any of the other exemplary forms perception data described elsewhere herein gestures, galvanic skin response, etc.) may be similarly correlated to particular media data treatments.

Returning to FIG. 2, at operation 245 a media data modification function associated with the perception data is determined from the MDEC database. A particular modification function may be identified through a search of the MDEC database as one or more lookup table keyed off values of one or more perception data fields. For example, in FIG. 6A an MDEC record may be identified/selected if a value or condition defined perception data field 0, or perception data field 1, or on perception data field N, matches or otherwise satisfies a value of corresponding field present in the perception data 149. Alternatively, a record in the MDEC database may be identified where values or conditions defined in more than one of the perception data fields 0-N satisfy the corresponding fields in the perception data 149.

Continuing with FIG. 2, at operation 250 any modification functions identified from the MDEC database are performed on the media data identified with the stored media data-perception association. Generally, a modification function defines a treatment or effect applicable to a particular form of media data. In exemplary embodiments, the modification function is a filter or transformation that may be applied to a particular form of media data through one or more mathematical (matrix) operations. Where media data is image data, for example corresponding to a still frame photograph, any image processing/graphical data manipulation conventional to digital post-processing of such media data may performed at operation 250. Exemplary modifications include: image scaling, digital brightness/contrast adjustments, digital toning (e.g., conversion of color to sepia), sharpening, etc. In one particular embodiment where media data includes 4D light fields, for example where the media capture device is a light-field camera, the modification function entails refocusing of an image defined in the media data and/or stereo image construction. For embodiments where media data is time sequenced moving frame data, for example corresponding to audio/video (A/V) frames, any image processing/graphical data manipulation conventional to digital post-processing of such image data may performed at operation 250. Similarly, any audio processing conventional to post-production tools for such audio data may be performed at operation 250, including, but not limited to: audio mixing, overlay of background thematic music, and dubbing of a foreign language.

Notably, the one or more post-capture media data modification performed at operation 245 may be resource intensive and require a significant amount of processing time, and so having such activity automated conditionally on specific operator perception qualifications as defined in the MDEC is advantageous. For example, referring again to FIG. 6, a refocusing of image data may be performed only where the operator's attention within a frame during capture was determined via perceptual data sensors. Or compression of media data 119 may be at a variable bit rate with lowest compression ratio applied to the operator's attention region within a frame as determined during capture. Referring still to FIG. 6, where the modification function entails overlaying a background music on A/V media data, the music may be selected from a palette predetermined to fit certain values of mood fields (sad, happy, etc.) included in the perception data 149.

Continuing with description of method 201 in FIG. 2, at operation 255 the modified media data is stored. In advantageous embodiments, the modified media data is stored in a manner that retains the association with the perception data such that modified media data is at least discernible as modified. In advantageous embodiments, the precise modification functions are discernible from the stored modified media data. The media data, as modified may be stored to the media data storage 130 (FIG. 1), in addition to the media data 119. Alternatively, the media data, as modified, may be automatically stored to a secondary location (e.g., a social media site, etc.).

In embodiments, captured media data is annotated based on operator perception data. As shown in FIG. 1, in certain embodiments the CMMS 101 further includes a media meta-data annotation module 175. The media meta-data annotation module 175 is drawn in dashed line to emphasize it is an optional component of CMMS 101. Generally, the media meta-data annotation module 175 is responsible for transforming the perception-media data association 155 into meta-data that is linked or embedded with the associated media data. In particular embodiments, for example as shown in FIG. 4, various circuitry and/or instantiations represented by the media meta-data annotation module 175 access a perception-media data association stored in memory at operation 410, access the corresponding media data at operation 415, and perform operation 275 of FIG. 2.

Referring further to FIG. 2, annotation of the media data with operator meta-data may be performed in addition to modification of the media data itself, or in the alternative. For example, annotation of the media data with operator meta-data is one exemplary means of identifying stored media data as modified and may further identify an unmodified version of the media data in circumstances where an originally generated media file is not replaced by modified media data file. In certain such embodiments, meta-data associated with the modified media data is indicative the modification functions performed, and/or indicative of one or more values of the perception data, and/or indicative of the original, unmodified media file. As such, meta-data associated with the modified media data may then further serve as a basis for reversing or discarding modifications previously automatically performed based on perception data. Where the modification function is reversible mathematically, an inverse process may be identified. For example, a modification function associated with the perception data may be determined from the media data effect correlation database, and the media data then returned to unmodified form by applying an inverse of the modification function to the media. An ability to mathematically recover the original media file may only apply to a small minority of post-production processing, however.

FIGS. 6B, 6C illustrate another embodiment where modification of a media data file may be removed by identifying, from a modified media data file containing the media data, a second media data file containing the media data in unmodified form (e.g., where the modification performed at operation 250 (FIG. 2) generates a separate copy of the media data 119). A media data modification pipeline is illustrated in FIG. 6B where, based on a perception-media data association 155, a modification function 620 is applied to the media data 119 to arrive at modified media data 621, substantially as described elsewhere herein. As shown in FIG. 6C, operator meta-data 540 or other modified media meta data 622 that is linked with the modified media data 621 (e.g., embedded in a modified media data file) is then utilized to maintain a link to the unmodified media data 119. For example, a path, etc. to media data 119 may be identified in the modified media meta data 622 and a discard option presented to a user (e.g., during an editing or browsing session, etc.) may trigger access of the media data 119 in storage 130 via the identified path. This same meta-data may be further utilized to replace the modified media data 621 (e.g., in response to a user confirming perception-based modification is to be discarded), or to delete the media data 119 (e.g., in response to a user confirming the modified media data is to become the only data file version).

Where no modification of the media data has occurred, the annotation of the media data with operator meta-data transforms the perception-media data association stored in memory at operation 230 into a more permanent data structure. As shown in FIG. 2, the operator meta-data is generated at operation 275 from the perception-media data association. The operator-meta data is generally indicative of one or more perception data field, and in certain embodiments includes all fields of perception data 149 (FIG. 1). The operator meta-data is then stored as part of a media data file at operation 276, or is stored as a separate operator meta-data file at operation 278, which is then linked at operation 280 to a media data file. Thus, a descriptor of mood, attention, etc. of the capture device operator is stored in conjunction with media files, such as images and videos. FIGS. 5B, and 5C illustrate perception data structures and links between perception data structures and media data structures, in accordance with embodiments. FIG. 5B depicts one exemplary data structure in which operator meta-data 540 is embedded into meta-data 530 of the media data file 510, which further contains media data 119 (as modified, or not). Any meta-data assigned by the media capture device (e.g., exposure setting, capture time, location and other environmental such as weather conditions, etc.) is retained as capture meta-data 535. FIG. 5C depicts an alternative exemplary data structure in which operator meta-data 540 is stored as a meta-data file 560, which is linked to the appropriate media data file 510. Media data file 510 may then retain its native structure as output from a capture device, for example including only the capture meta-data 535 assigned by the media capture device, and the captured media data 119.

In embodiments, stored media data is accessed, processed or output based on, or in a manner inclusive of, operator perception data. As shown in FIG. 1, in certain embodiments the CMMS 101 further includes a media data access application programming interface (API) 190. The media data access API 190 is drawn in dashed line to emphasize it is an optional component of CMMS 101. Nonetheless, the data access API 190 may be incorporated along with any of the other components depicted in FIG. 1. For example, in one specific embodiment of the CMMS 101, the data access API 190 is incorporated along with the media meta-data annotation module 175, the media data modification module 165, and the perception assignment module 150.

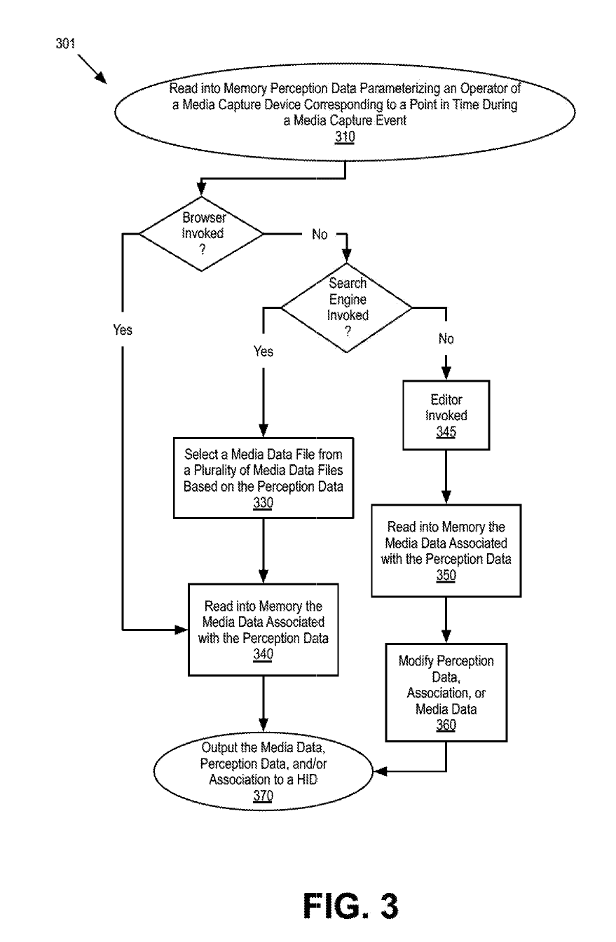

Generally, the media data access API 190 specifies data structures and functions that include perception data, and that are exposed to one or more modules or instances invoked on a platform to access the media data. In particular embodiments, for example as shown in FIG. 4, the media data access API 190 provides an interface to a media data browser at operation 420, and/or provides an interface to a media data search engine at operation 430, and/or provides an interface to a media data editor at operation 440. Processes performed by the corresponding module circuitry and/or instantiations are further described in the context of FIG. 3, which is a flow diagram illustrating an exemplary method 301 for accessing and managing captured media data based on perceptions of a capture device operator, in accordance with an embodiment.

Referring to FIG. 3, the method 301 begins at operation 310 where perception data that parameterizes an operator of a media capture device, and corresponds with a point in time when media data is captured by the capture device, is read into memory. The memory may again be a portion of any conventional electronic memory (e.g., eDRAM cache of processor executing method 301, etc.) and it may be a second portion of the same electrical memory used employed in the method 201, or a portion of a separate electrical memory. In one exemplary embodiment, the perception data is operator meta-data 540, described elsewhere herein. In another embodiment, the perception data is perception data 149 previously stored in memory at operation 230 (FIG. 2). The flow control of the method. 301 then branches conditionally depending on whether a media data browser, media data search engine, or media data editor instance is invoked.

In one exemplary embodiment where a browser is invoked (e.g., media browser 192 in FIG. 1), method 301 proceeds to operation 320 where a stored media data file associated with the perception data read into memory at operation 310 is also read into memory. At operation 370 one or more of the media data, associated perception data, or an indication of the association is output to a human interface device (HID) communicatively coupled to the instantiating processor, such as HID 199 in FIG. 1. Generally, any HID conventional in the art may be utilized, such as, but not limited to, a display screen, audio speakers, haptic device, etc. In a specific embodiment, for example where the browser serves as a viewfinder window (e.g., integrated into or in communication with a capture device) outputting to a display device captured image data, both the media data (e.g., image of subject) and perception data (e.g., gesture of operator sensed at time of media capture) are output to the display device.

In another exemplary embodiment where a search engine is invoked (e.g., media search engine 194 in FIG. 1), method 301 proceeds to operation 330 where one or more stored media data file is identified and/or selected based on a value of one or more field in the perception data stored in memory. For example, all accessible media data files may be analyzed for perception data field values matching those of the perception data read into memory at operation 310. The media data associated with matching perception data is then read into memory at operation 340 and output to the HID at operation 370. In one embodiment where the media data is a video data file including a time-sequenced series of image data frames, the data file is analyzed for locations of frames within a captured video sequence within the file that have been associated with the perception data field value in the search query. For example, where a system user provides a perception data field search criteria, such as mood=“happy”, one or more frame sequences from one or more media data file may be identified on the basis of a perception data item containing a mood field value of “happy” and output to the user via the HID. With this technique, one or more points in time within hours of media data may be rapidly identified through automated search.

In another embodiment depicted in FIG. 3, method 301 proceeds to operation 345 where a media data editor is invoked (e.g., media editor 196 in FIG. 1). Method 301 then proceeds to operation 350 where media data associated with the perception data is read into memory. At operation 360 the media data is edited through any post-production digital processing algorithm conventional in the art, such as any of those describe elsewhere herein in the context of operation 250 (FIG. 2). In further embodiments, values of the perception data itself are edited through functions exposed by the media access API 190, for example by implementing any of the modification functions in the MDEC database. For such embodiments, the editing of the media data is not automated to the extent described in the context of method 201 and instead a user interface for selection of the media data for editing is predicated on the perception data association. The media data so edited is then output at operation 370 using any conventional HID.

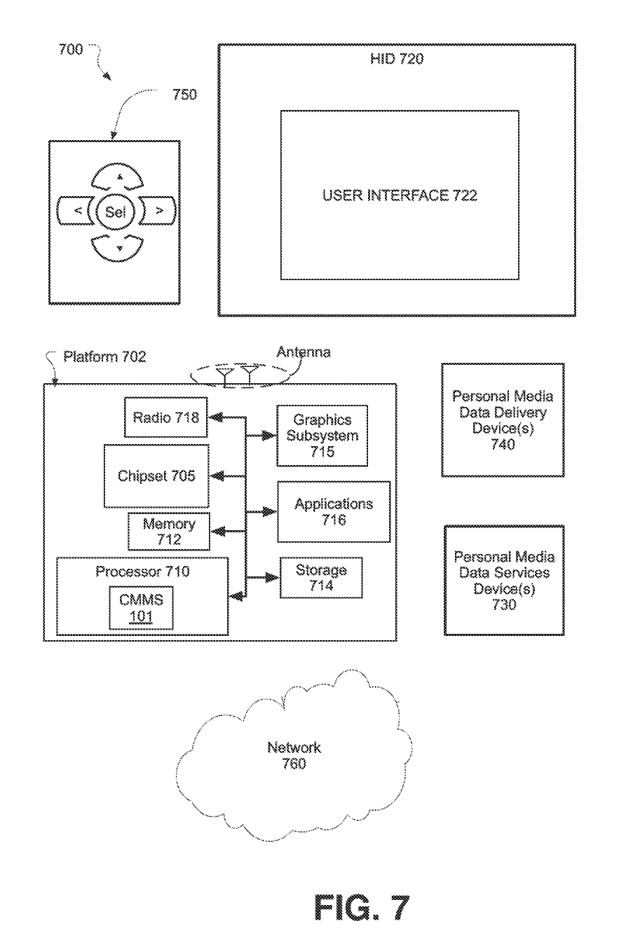

FIG. 7 is an illustrative diagram of an exemplary system 700, in accordance with embodiments. System 700 may implement all or a subset of the various functional blocks depicted in FIG. 1. For example, in one embodiment the CMMS 101 is implemented by the system 700. System 700 may be a mobile device although system 700 is not limited to this context. For example, system 700 may be incorporated into a laptop computer, ultra-laptop computer, tablet, touch pad, portable computer, handheld computer, palmtop computer, cellular telephone, smart device (e.g., smart phone, smart tablet or mobile television), mobile internet device (MID), messaging device, data communication device, and so forth. System 700 may also be an infrastructure device. For example, system 700 may be incorporated into a large format television, set-top box, desktop computer, or other home or commercial network device.

In various implementations, system 700 includes a platform 702 coupled to a HID 720. Platform 702 may receive captured personal media data from a personal media data services device(s) 730, a personal media data delivery device(s) 740, or other similar content source. A navigation controller 750 including one or more navigation features may be used to interact with, for example, platform 702 and/or HID 720. Each of these components is described in greater detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 710 may be a multi-core processor(s), multi-core mobile processor(s), and so forth. In one exemplary embodiment, processor 710 invokes or otherwise implements processes and/or methods of the CMMS 101 and the various modules described in as components of CMMS 101 elsewhere herein.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video media data for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, Display Port, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The perception-media data associations and related media data management and accessing techniques described herein may be implemented in various hardware architectures. For example, graphics and/or video functionality may be integrated within a chipset. Alternatively, a discrete graphics and/or video processor may be used. As still another embodiment, the methods and functions described herein may be provided by a general purpose processor, including a multi-core processor. In further embodiments, the methods and functions may be implemented in a purpose-built consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, HID 720 may include any television type monitor or display. HID 720 may include, for example, a computer display screen, touch screen display, video monitor, television-like device, and/or a television. HID 720 may be digital and/or analog. In various implementations, HID 720 may be a holographic display. Also, HID 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on HID 720.

In various implementations, personal media services device(s) 730 may be hosted by any national, international and/or independent service and thus accessible to platform 702 via the Internet, for example. Personal media services device(s) 730 may be coupled to platform 702 and/or to display 720. Platform 702 and/or personal services device(s) 730 may be coupled to a network 760 to communicate (e.g., send and/or receive) media information to and from network 760. Personal media delivery devices) 740 also may be coupled to platform 702 and/or to HID 720.

In various implementations, personal media data services device(s) 730 may include a cable television box, personal computer, network, telephone, Internet enabled devices or appliance capable of delivering digital information and/or content, and any other similar device capable of unidirectionally or bidirectionally communicating content between a media data provider and platform 702, via network 760 or directly. It will be appreciated that the content may be communicated unidirectionally and/or bidirectionally to and from any one of the components in system 700 and a provider via network 760. Examples of personal media include any captured media information including, for example, video, music, medical and gaming information, and so forth.

Personal media data services device(s) 730 may receive content including media information with examples of content providers including any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., HID 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or HID 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other personal media services device(s) 730 or personal media delivery device(s) 740 even when the platform is turned “off.” In addition, chipset 705 may include hardware and/or software support for 8.1 surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 700 may be integrated. For example, platform 702 and personal media data services device(s) 730 may be integrated, or platform 702 and captured media data delivery device(s) 640 may be integrated, or platform 702, personal media services device(s) 730, and personal media delivery device(s) 740 may be integrated, for example. In various embodiments, platform 702 and HID 720 may be an integrated unit. HID 720 and content service device(s) 730 may be integrated, or HID 720 and personal media delivery device(s) 740 may be integrated, for example. These examples are not meant to limit the present disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

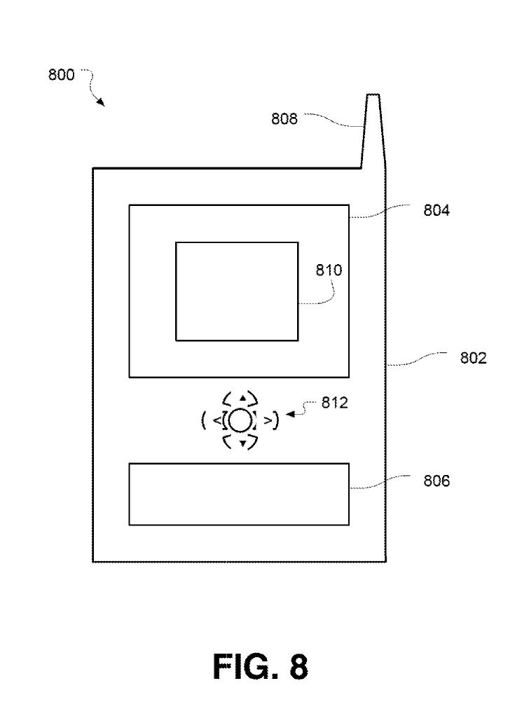

As described above, system 700 may be embodied in varying physical styles or form factors. FIG. 8 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interact device (MID), messaging device, data communication device, and so forth.

Examples of a mobile computing device also may include computers configured to be worn by a person, such as a wrist computer, linger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a housing 802, a display 804, pan input/output (I/O) device 806, and an antenna 808. Device 800 also may include navigation features 812. Display 804 may include any suitable display unit for displaying information appropriate for a mobile computing device. I/O device 806 may include any suitable ISO device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

Various embodiments described herein may be implemented using hardware elements, software elements, or a combination of both. Examples of hardware elements or modules include: processors, microprocessors, circuitry, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software elements or modules include: programs, applications, computer programs, application programs, system programs, machine programs, operating system software, middleware, firmware, routines, subroutines, functions, methods, procedures, software interfaces, application programming interfaces (API), instruction sets, computing code, computer code, code segments, computer code segments, words, values, symbols, or any combination thereof. Determining whether an embodiment is implemented using hardware elements and/or software elements may vary in accordance with any number of factors considered for the choice of design, such as, but not limited to: desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable storage medium. Such instructions may reside, completely or at least partially, within a main memory and/or within a processor during execution thereof by the machine, the main memory and the processor portions storing the instructions then also constituting a machine-readable storage media. Instructions representing various logic within the processor, which when read by a machine may also cause the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to particular exemplary embodiments

A media data management system may include one or more electronic memory; and a perception assignment module including logic to receive perception data parameterizing an operator of a media capture device, the perception data corresponding a media capture event conducted by the media capture device, generate an association between the perception data and media data output by the media capture device during the media capture event, and store the association to the one or more memory.

In a further example, the media data management system may include one or more media capture sensors coupled to at least one of the one or more memory and the perception assignment module, wherein the media capture sensor is to collect information from which the media data is derived.

In a further example, the media data management system may include one or more media capture sensors coupled to at least one of the one or more memory and perception assignment module, wherein the media capture sensors are to collect information from which the media data is derived, a perception sensor coupled to at least one of the one or more memory and perception assignment module, wherein the perception sensor is to collect a signal from which the perception data is derived, a human interface device (HID) coupled to at least one of the one or more memory, perception assignment module, and the one or more media capture sensors, wherein the HID is to output at least one of the perception data, or the association.

In a further example, the media data management system may include a meta-data assignment module to generate operator meta-data indicative of one or more fields of the perception data corresponding to one or more point in time during the media capture event, and link or embed the media data with the operator meta-data.

In a further example, the media data management system may include a media data effect correlation database comprising one or more perception data field and a plurality of media data modification functions, wherein individual modification functions are associated with one or more perception data field value. The system may further include and a media data modification module to access the media data effect correlation database, determine from the database a modification function associated with one or more values in the perception data, perform the modification function on the media data, and store the media data, as modified, in association with the perception data.

In a further example, the media data management system may include a media data effect correlation database comprising one or more perception data field and a plurality of media data modification functions, wherein individual modification functions are associated with one or more perception data field value. The system may further include a media data modification module to access the media data effect correlation database, determine from the database a modification function associated with one or more values in the perception data, perform the modification function on the media data, and store the media data, as modified, in association with the perception data. The system may further include a meta-data assignment module to link or embed the media data, as modified, with operator meta-data indicative of at least one of the modification function, and one or more values of the perception data.

In a further example, the system may further include an API specifying a data structure including the perception data, wherein one or more processor is further to invoke at least one of a media data browser implementing an API further specifying a function to read into the memory stored media data files and output media data to one or more human interface device (HID) along with the associated perception data, a media data search engine implementing an API specifying a function to select a file containing the media data from a plurality of media data files based on the perception data, or a media data editor implementing an API specifying a function to modify at least one of the perception data, or the media data.

In a further example, the system may further include an API specifying a data structure including the perception data, wherein one or more processor is further to invoke at least one of a media data browser implementing an API further specifying a function to modify the media data by identifying, from a modified media data file containing the media data, a second media data file containing the media data in unmodified form, or determining a modification function associated with the perception data in the media data effect correlation database, and returning the media data to unmodified form based on the second media data file or by applying an inverse of the modification function to the media.

In a further example, where the media data comprises still frame image data or time-sequenced video frame data; the media data management system may include a middleware module to receive sensor data collected from the operator during the media capture event, wherein the sensor data comprises at least one of: an optical image of the operator; an audio recording of the operator; a heart rate of the operator; a galvanic skin response of the operator; and electrical brain activity of the operator, and the middleware modules is to determine the perception data based on the sensor data, wherein the perception data comprises at least one of: a mood; an attention level; or a cognitive load.

In another example, a media data access system includes one or more human interface device (HID), one or more electronic memory, and a capture media management module coupled to the one or more memory and the one or more HID. As a further example, the capture media management module is to store, in the one or more memory, perception data parameterizing an operator of a media capture device, the perception data corresponding a media capture event conducted by the media capture device, identify media data associated with perception data, read into the one or more memory the media data, and output the media data to the one or more HID.

In another example, a media data access system includes further includes an API specifying a data structure including one or more field of the perception data, wherein the capture media management module is further to invoke at least one of: a media data browser implementing an API further specifying a function to read into the memory stored media data files and output media data to the one or more HID along with the associated perception data; a media data search engine implementing an API specifying a function to select a media data file from a plurality of media data files based on the perception data; or a media data editor implementing an API specifying a function to modify at least one of the perception data, the association between the perception data and media data, or the media data.

In another example, a media data access system includes further includes a media data effect correlation database comprising a plurality of media data modification functions keyed to perception data field values, and an API specifying a data structure including one or more field of the perception data. In a further example, the capture media management module is further to invoke at least one of a media data editor implementing an API specifying one or more function to modify the media data by: identifying, from a modified media data file containing the media data, a second media data file containing the media data in unmodified form, or determining a modification function associated with the perception data in the media data effect correlation database; or returning the media data to unmodified form based on the second media data file or by applying an inverse of the modification function to the media.

Another example includes a computer-implemented method for managing media data, wherein the method includes receiving perception data parameterizing an operator of a media capture device, the perception data corresponding a media capture event conducted by the media capture device, generating an association between media data output by the media capture device during the media capture event and the perception data, and storing the association in an electronic memory.

In another example, a computer-implemented method further includes generating the media data via a one or more sensors having a field of view that is exclusive of the operator, collecting the perception data during one or more point in time during the media capture event via one or more sensors having a field of view inclusive of the operator, and outputting to the HID at least one of the perception data, or the association.

In another example, a computer-implemented method further includes generating operator meta-data indicative of one or more fields of the perception data, and linking or embedding the media data with the operator meta-data.

In another example, a computer-implemented method further includes accessing a media data effect correlation database comprising one or more perception data field and a plurality of media data modification functions, an individual modification function associated with one or more perception data field value, determining from the database a modification function associated with one or more values in the perception data, performing the modification function on the media data, and storing the media data, as modified, in association with the perception data.

In another example, a computer-implemented method further includes accessing a media data effect correlation database comprising one or more perception data field and a plurality of media data modification functions, wherein individual modification functions are associated with one or more perception data field value, determining from the database a modification function associated with one or more value in the perception data, performing the modification function on the media data, and storing the media data, as modified, in association with the perception data, and linking or embedding the media data, as modified, with operator meta-data indicative of at least one of the modification function, or one or more value of the perception data.

In another example, a computer-implemented method further includes invoking at least one of: a media data browser implementing an API further specifying a function to read into the memory stored media data files and output media data to one or more human interface device (HID) along with the associated perception data, a media data search engine implementing an API specifying a function to select a file containing the media data from a plurality of media data files based on the perception data; or a media data editor implementing an API specifying a function to modify at least one of the perception data, or the media data.

In another example, a computer-implemented method further includes identifying, from a modified media data file containing the media data, a second media data file containing the media data in unmodified form, or determining a modification function associated with the perception data in the media data effect correlation database, and returning the media data to unmodified form based on the second media data file or by applying an inverse of the modification function to the media.

In another example, where the media data comprises: still frame image data or time sequenced video frame data, a computer-implemented method further includes receiving sensor data collected from the operator during the media capture event, wherein the sensor data comprises at least one of: an optical image of the operator; an audio recording of the operator; a heart rate of the operator; a galvanic skin response of the operator; or electrical brain activity of the operator; and the computer-implemented method further includes determining the operator perception data based on the sensor data, wherein the operator perception data comprises at least one of: a mood; an attention level; or a cognitive load.

In another example, at least one machine-readable storage medium includes machine-readable instructions, that in response to being executed on a computing device, cause the computing device to manage media data by receiving perception data parameterizing an operator of a media capture device, the perception data corresponding to a media capture event conducted by the media capture device, generating an association between the media capture device during the media capture event and the perception data, and storing the association in one or more electronic memory.

In another example, at least one machine-readable storage medium further includes instructions that in response to being executed on the computing device, cause the computing device to manage media data by at least one of generating operator meta-data indicative of one or more fields of the perception data, and linking or embedding the media data with the operator meta-data; or accessing a media data effect correlation database comprising one or more perception data field and a plurality of media data modification functions, wherein individual modification functions associated with one or more perception data field values, determining from the database a modification function associated with one or more values in the perception data, performing the modification function on the media data, and storing the media data, as modified, in association with the perception data.

In another example, at least one machine-readable storage medium further includes instructions that in response to being executed on the computing device, cause the computing device to invoke at least one of a media data browser implementing an API further specifying a function to read into the memory stored media data files and output media data to one or more human interface device (HID) along with the associated perception data; a media data search engine implementing an API specifying a function to select a file containing the media data from a plurality of media data files based on the perception data; or a media data editor implementing an API specifying a function to modify at least one of the perception data, or the media data.

It will be recognized that the invention is not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

1-23. (canceled)

24. A media data management system, comprising:
one or more electronic memory; and
a perception assignment module including logic to:
receive perception data parameterizing an operator of a media capture device, the perception data corresponding a media capture event conducted by the media capture device;
generate an association between the perception data and media data output by the media capture device during the media capture event; and
store the association to the one or more memory.

25. The system of claim 24, further comprising:
one or more media capture sensors coupled to at least one of the one or more memory and the perception assignment module, wherein the media capture sensor is to collect information from which the media data is derived.

26. The system of claim 24, further comprising:
one or more media capture sensors coupled to at least one of the one or more memory and perception assignment module, wherein the media capture sensors are to collect information from which the media data is derived;
a perception sensor coupled to at least one of the one or more memory and perception assignment module, wherein the perception sensor is to collect a signal from which the perception data is derived; and
a human interface device (HID) coupled to at least one of the one or more memory, perception assignment module, and the one or more media capture sensors, wherein the HID is to output at least one of the perception data, or the association.

27. The system of claim 24, further comprising a meta-data assignment module to:
generate operator meta-data indicative of one or more fields of the perception data corresponding to one or more point in time during the media capture event; and
link or embed the media data with the operator meta-data.

28. The system of claim 24, wherein the system further comprises:
a media data effect correlation database comprising one or more perception data field and a plurality of media data modification functions, wherein individual modification functions are associated with one or more perception data field value; and
a media data modification module to:
access the media data effect correlation database;
determine from the database a modification function associated with one or more values in the perception data;
perform the modification function on the media data; and
store the media data, as modified, in association with the perception data.

29. The system of claim 24, wherein the system further comprises:
a media data effect correlation database comprising one or more perception data field and a plurality of media data modification functions, wherein individual modification functions are associated with one or more perception data field value;
a media data modification module to:
access the media data effect correlation database;
determine from the database a modification function associated with one or more values in the perception data;
perform the modification function on the media data; and
store the media data, as modified, in association with the perception data; and
a meta-data assignment module to link or embed the media data, as modified, with operator meta-data indicative of at least one of the modification function, and one or more values of the perception data.

30. The system of claim 24, further comprising an application programming interface (API) specifying a data structure including the perception data, wherein one or more processor is further to invoke at least one of:
a media data browser implementing an API further specifying a function to read into the memory stored media data files and output media data to one or more human interface device (HID) along with the associated perception data;
a media data search engine implementing an API specifying a function to select a file containing the media data from a plurality of media data files based on the perception data; or
a media data editor implementing an API specifying a function to modify at least one of the perception data, or the media data.

31. The system of claim 24, further comprising an application programming interface (API) specifying a data structure including the perception data, wherein one or more processor is further to invoke a media data editor implementing an API specifying a function to modify the media data by:
identifying, from a modified media data file containing the media data, a second media data file containing the media data in unmodified form, or determining a modification function associated with the perception data in the media data effect correlation database; and
returning the media data to unmodified form based on the second media data file or by applying an inverse of the modification function to the media.

32. The system of claim 24, wherein the media data comprises: still frame image data or time-sequenced video frame data; and
wherein the system further comprises a middleware module to:
receive sensor data collected from the operator during the media capture event, wherein the sensor data comprises at least one of:
an optical image of the operator;
an audio recording of the operator;
a heart rate of the operator;
a galvanic skin response of the operator; or
electrical brain activity of the operator; and
determine the perception data based on the sensor data, wherein the perception data comprises at least one of:
a mood;
an attention level; or
a cognitive load.

33. A media data access system, comprising:
one or more human interface device (HID);
one or more electronic memory; and
a capture media management module coupled to the one or more memory and the one or more HID, wherein the capture media management module is to:
store, in the one or more memory, perception data parameterizing an operator of a media capture device, the perception data corresponding a media capture event conducted by the media capture device;
identify media data associated with perception data;
read into the one or more memory the media data; and
output the media data to the one or more HID.

34. The system of claim 33, further comprising an application programming interface (API) specifying a data structure including one or more field of the perception data, wherein the capture media management module is further to invoke at least one of:
a media data browser implementing an API further specifying a function to read into the memory stored media data files and output media data to the one or more HID along with the associated perception data;
a media data search engine implementing an API specifying a function to select a media data file from a plurality of media data files based on the perception data; or
a media data editor implementing an API specifying a function to modify at least one of the perception data, the association between the perception data and media data, or the media data.

35. The system of claim 33, further comprising:
a media data effect correlation database comprising a plurality of media data modification functions keyed to perception data field values; and
an application programming interface (API) specifying a data structure including one or more field of the perception data;
wherein the capture media management module is further to invoke at least one of a media data editor implementing an API specifying one or more function to modify the media data by:
identifying, from a modified media data file containing the media data, a second media data file containing the media data in unmodified form, or determining a modification function associated with the perception data in the media data effect correlation database; or
returning the media data to unmodified form based on the second media data file or by applying an inverse of the modification function to the media.

36. A computer-implemented method for managing media data, the method comprising:
receiving perception data parameterizing an operator of a media capture device, the perception data corresponding a media capture event conducted by the media capture device;
generating an association between media data output by the media capture device during the media capture event and the perception data; and
storing the association in an electronic memory.

37. The method of claim 36, further comprising:
generating the media data via a one or more sensors having a field of view that is exclusive of the operator;
collecting the perception data during one or more point in time during the media capture event via one or more sensors having a field of view inclusive of the operator; and
outputting to the HID at least one of the perception data, or the association.

38. The method of claim 36, further comprising:
generating operator meta-data indicative of one or more fields of the perception data; and
linking or embedding the media data with the operator meta-data.

39. The method of claim 36, further comprising:
accessing a media data effect correlation database comprising one or more perception data field and a plurality of media data modification functions, an individual modification function associated with one or more perception data field value;
determining from the database a modification function associated with one or more values in the perception data;
performing the modification function on the media data; and
storing the media data, as modified, in association with the perception data.

40. The method of claim 36, further comprising:
accessing a media data effect correlation database comprising one or more perception data field and a plurality of media data modification functions, wherein individual modification functions are associated with one or more perception data field value;
determining from the database a modification function associated with one or more value in the perception data;
performing the modification function on the media data; and
storing the media data, as modified, in association with the perception data; and
linking or embedding the media data, as modified, with operator meta-data indicative of at least one of the modification function, or one or more value of the perception data.

41. The method of claim 36, further comprising invoking at least one of:
a media data browser implementing an API further specifying a function to read into the memory stored media data files and output media data to one or more human interface device (HID) along with the associated perception data;
a media data search engine implementing an API specifying a function to select a file containing the media data from a plurality of media data files based on the perception data; or
a media data editor implementing an API specifying a function to modify at least one of the perception data, or the media data.

42. The method of claim 36, further comprising:
identifying, from a modified media data file containing the media data, a second media data file containing the media data in unmodified form, or determining a modification function associated with the perception data in the media data effect correlation database; and
returning the media data to unmodified form based on the second media data file or by applying an inverse of the modification function to the media.

43. The method of claim 36, wherein the media data comprises: still frame image data or time sequenced video frame data; and
wherein the method further comprises:
receiving sensor data collected from the operator during the media capture event, wherein the sensor data comprises at least one of:
an optical image of the operator;
an audio recording of the operator;
a heart rate of the operator;
a galvanic skin response of the operator; or
electrical brain activity of the operator; and
determining the operator perception data based on the sensor data, wherein the operator perception data comprises at least one of:
a mood;
an attention level; or
a cognitive load.

44. At least one machine-readable storage medium including machine-readable instructions, that in response to being executed on a computing device, cause the computing device to manage media data by:
receiving perception data parameterizing an operator of a media capture device, the perception data corresponding to a media capture event conducted by the media capture device;
generating an association between the media capture device during the media capture event and the perception data; and
storing the association in one or more electronic memory.

45. The machine-readable medium of claim 44, further comprising instructions that in response to being executed on the computing device, cause the computing device to manage media data by at least one of:
generating operator meta-data indicative of one or more fields of the perception data, and linking or embedding the media data with the operator meta-data; or
accessing a media data effect correlation database comprising one or more perception data field and a plurality of media data modification functions, wherein individual modification functions associated with one or more perception data field values, determining from the database a modification function associated with one or more values in the perception data, performing the modification function on the media data, and storing the media data, as modified, in association with the perception data.

46. The machine-readable medium of claim 44, further comprising instructions that in response to being executed on the computing device, cause the computing device to invoke at least one of:
a media data browser implementing an API further specifying a function to read into the memory stored media data files and output media data to one or more human interface device (HID) along with the associated perception data;
a media data search engine implementing an API specifying a function to select a file containing the media data from a plurality of media data files based on the perception data; or
a media data editor implementing an API specifying a function to modify at least one of the perception data, or the media data.
